(19) United States
(12) Patent Application Publication
(10) Pub. No.: US 2006/0062286 A1
(43) Pub. Date: Mar. 23, 2006

(54) Data training in memory device

(76) Inventors: Kwang-Il Park, Yongin-si (KR); Seong-Jin Jang, Seongnam-si (KR); Ho-Young Song, Hwaseong-si (KR)

Correspondence Address: LAW OFFICE OF MONICA H CHOI, P O BOX 3424, DUBLIN, OH, 430160204, US

(21) Appl. No.: 11/128,795

(22) Filed: May 13, 2005

(30) Foreign Application Priority Data
Sep. 21, 2004 (KR) 2004-75485

(51) Int. Cl. H04B 1/38

(52) U.S. Cl. 375/219

(57) ABSTRACT

For data training in a memory device, a selecting unit selects a subset of data bit patterns received from a controlling device. In addition, a storing unit comprised of memory cells of the memory device stores the selected subset of data bit patterns. Such stored data bit patterns are then sent back to the controlling device that determines the level of data skew. Such data training more accurately reflects the actual paths and environments of the transmitted data bits.

### BACKGROUND OF THE INVENTION

This application claims priority to Korean Patent Application No. 2004-75485, filed on Sep. 21, 2004, in the Korean Intellectual Property Office, the disclosure of which is incorporated herein in its entirety by reference.

1. Field of the Invention

The present invention relates generally to memory devices, and more particularly, to an apparatus, system, and method for data training of the memory device.

2. Description of the Related Art

In a system with a data processor and a memory device, the data processor concurrently processes many bits of data for high-speed signal processing. For such high-speed signal processing, many bits of data should be continuously and concurrently supplied to the data processor from the memory device. Thus, high-speed signal processing requires high speed data transmission and reception.

When many bits of output data concurrently control switching, much current is supplied to the switching devices from a power line. Such current consumption in the switching devices causes switching noise due to a parasitic component of the power line to result in delay and distortion in the output data.

When many bits of output data are switched in one direction, and less bits of output data are switched in a different direction (for example, opposite direction), delay times between such data of different directions are different resulting in skew (i.e., a timing inconsistency) between such data of different directions. Such skew becomes significant with increased bits of output data that are switched, with increased parasitic component of the power line, and with higher speed operation.

For data that is read from or recorded in a memory device (for example, a DRAM—dynamic random access memory device), data training is performed to control data skew. Generally, data training is for controlling data skew by using predetermined data patterns between a controlling device and the memory device. The data training is classified into two cases of where data is recorded in the memory device and where data is read from the memory device.

FIG. 1 shows a block diagram illustrating a conventional memory device 120 and a conventional data training method performed between the memory device 120 and a controlling device 110. The controlling device 110 includes a pattern generator (P/G) 113 for generating training data patterns, and a first transceiver 115 that is a Double Data Rate (DDR) circuit. The memory device 120 includes a pattern generator (P/G) 123 for generating training data patterns, and a second transceiver 125 that is also a DDR circuit. Data (DQ) comprised of data bit patterns is transmitted and received between the controlling device 110 and the memory device 120 through the DDR circuits 115 and 125.

When data is read from the memory device 120 for data training, predetermined data patterns are transmitted from the memory device 120 to the controlling device 110. When data is recorded in the memory device 120 for data training, predetermined data patterns are transmitted from the controlling device 110 to the memory device 120. The transmitted data patterns are compared with predetermined data patterns to determine success or failure of data transmission, and thus whether or not there is data skew. If necessary, data skew is controlled.

For such data training in the prior art of FIG. 1, the data pattern generator (P/G) 113 is needed in the controlling device 110 for the case of data being recorded in the memory device 120. In other words, data generated from the data pattern generator (P/G) 113 is transmitted to the memory device 120 to perform the data training.

For the case when data is recorded in the memory device 120, predetermined data patterns to be transmitted to the controlling device 110 should be previously stored in the memory device 120. However, in order to avoid inconvenience in the prior art, a conventional method installs the pattern generator 123 inside the memory device to generate the data patterns.

The data pattern generators 113 and 123 of FIG. 1 may be implemented with a linear feedback shift register. Data training performed using data generated through the data pattern generators 113 and 123 has a disadvantage in that a power noise of a memory core is not accurately reflected compared to the actual recording of data patterns in memory cells of the memory device 120, or to the actual reading of the data patterns from the memory cells of the memory device 120.

Specifically, the data pattern generator 123 installed in the memory device 120 not only increases an area of the memory device 120, but also causes inaccurate data training since the skew is actually determined using data not transmitted from the memory cells of the memory device 120. That is, use of the data pattern generator 123 is disadvantageous by not reflecting the actual paths and environments of data stored in the memory cells of the memory device 120.

### SUMMARY OF THE INVENTION

Accordingly, data training of the present invention includes storing data patterns in memory cells of a memory device.

For data training in a memory device according to an apparatus and method of the present invention, a selecting unit selects a subset of data bit patterns received from a controlling device. In addition, a storing unit comprised of memory cells of the memory device stores the selected subset of data bit patterns.

In another embodiment of the present invention, a transceiver disposed in the memory device receives the data bit patterns from the controlling device. In addition, the transceiver in the memory devices sends the selected subset of data bit patterns stored in the memory cells back to the controlling device.

In a further embodiment of the present invention, the selecting unit selects one of two substantially same data bit patterns that are received sequentially. Alternatively, the selecting unit selects an arbitrary one of two substantially different data bit patterns that are received sequentially. In another embodiment of the present invention, the selecting unit selects a middle one of at least three substantially same data bit patterns that are received sequentially. Alternatively, the selecting unit selects a majority one of at least three data bit patterns that are received sequentially.

In another embodiment of the present invention, a system for data training further includes the controlling device that transmits the data bit patterns. The controlling device includes a pattern generator for generating the data bit patterns transmitted to the memory device. The controlling device also includes a transceiver for transmitting the data bit patterns to the memory device.

In this manner, data training is performed by storing data bit patterns in memory cells of the memory device. Such stored data bit patterns are then sent back to the controlling device. Thus, such data training more accurately reflects the actual paths and environments of the data bits that are transmitted between the memory device and the controlling device.

### BRIEF DESCRIPTION OF THE DRAWINGS

The above and other features and advantages of the present invention will become more apparent when described in detailed exemplary embodiments thereof with reference to the attached drawings in which:

FIG. 1 is a block diagram illustrating a conventional memory device and a conventional data training method performed between the memory device and a controlling device;

FIG. 2 is a block diagram illustrating a memory device and a data training method performed between a memory device and a controlling device according to an embodiment of the present invention;

FIG. 3 is a timing diagram illustrating data transmitted and received, and signals used for transmitting and receiving data during operation of the components of FIG. 2, according to an embodiment of the present invention; and

FIG. 4 is a flowchart of steps for the data training method during operation of the components of FIG. 2, according to an embodiment of the present invention.

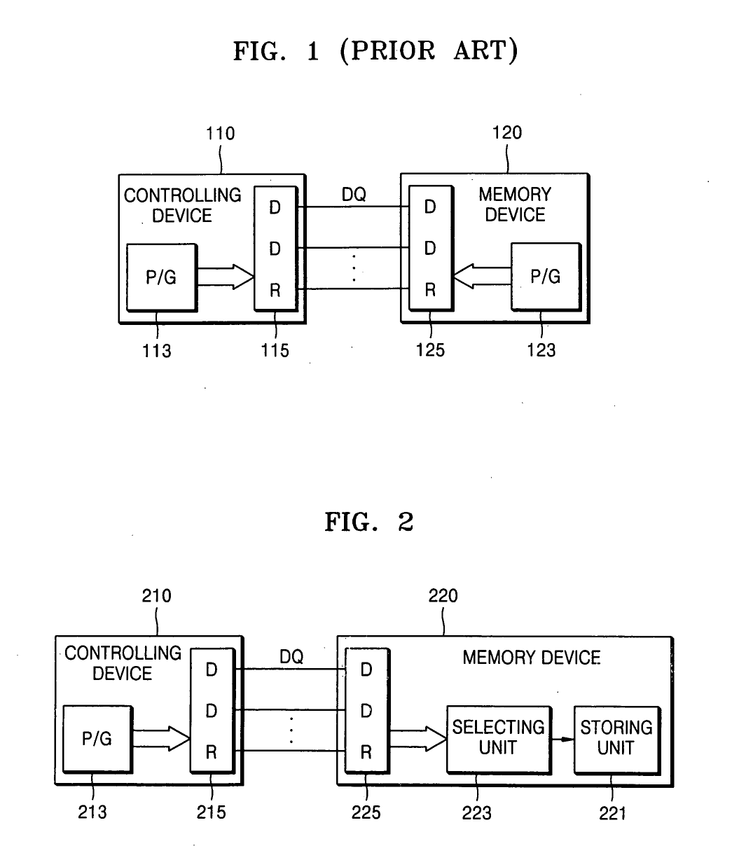

The figures referred to herein are drawn for clarity of illustration and are not necessarily drawn to scale. Elements having the same reference number in FIGS. 1, 2, 3, and 4 refer to elements having similar structure and/or function.

### DETAILED DESCRIPTION OF THE INVENTION

FIG. 2 is a diagram illustrating a memory device 220, and a data training method performed between the memory device and a controlling device 210 according to an embodiment of the present invention. Referring to FIG. 2, the controlling device 210 includes a data pattern generator 213 and a first transceiver 215. The first transceiver 215 is a Double Data Rate (DDR) circuit in one example embodiment of the present invention.

Further referring to FIG. 2, the memory device 220 includes a storing unit 221, a selecting unit 223, and a second transceiver 225. The second transceiver 225 is also implemented as a DDR circuit in one example embodiment of the present invention. The storing unit 221 includes memory cells of the memory device 220.

For data training between the controlling device 210 and the memory device 220, data bit patterns are transmitted and received through the first and second transceivers 215 and 225. Data training determines the amount of data skew during such transmitting and receiving of the data bit patterns between the controlling device 210 and the memory device 220.

In the case of reading data from the memory device 220, the memory device 220 transmits predetermined data patterns to the controlling device 210. The controlling device 210 compares the received data patterns with the predetermined data patterns to determine whether or not data skew is generated during such transmission and reception.

The present invention does not use a pattern generator (not shown) in the memory device 220 for generating the data bit patterns transmitted to the controlling device 210. Instead, in the present invention, a selected subset of the predetermined data bit patterns is stored after being received from the controlling device 210. Then such stored data bit patterns are transmitted back to the controlling device 210. In other words, a high-speed burst write is used to load data bit patterns in the memory device 220.

In addition, the memory device 220 includes the selecting unit 223. The controlling device 210 generates and transmits a sequence of a plurality of same data bit patterns to the memory device 220. The selecting unit 223 selects one of the same data bit patterns received sequentially from the controlling device 210 to be stored in the memory cells of the storing unit 221.

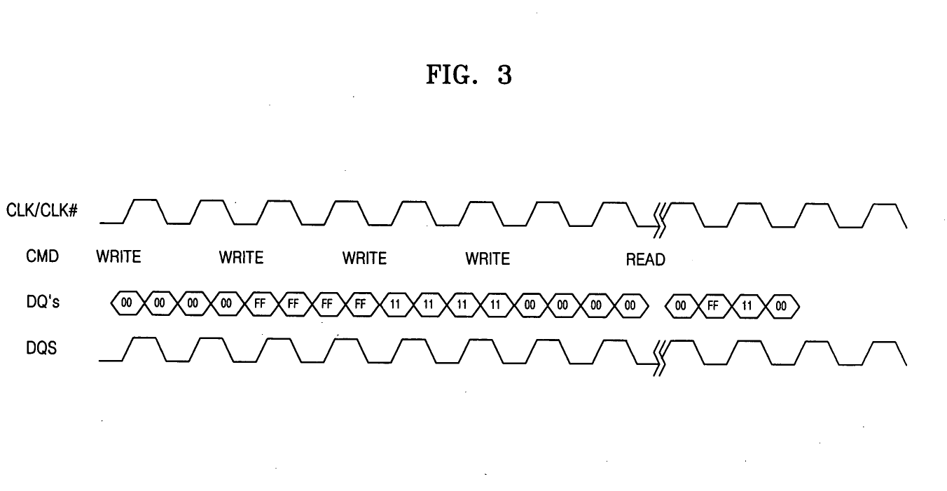

FIG. 3 is a timing diagram illustrating data transmitted and received, and signals used for transmitting and receiving data between the controlling device 210 and the memory device 220. Referring to FIG. 3, a write command or a read command signal (CMD) is generated. In addition, a main clock signal (CLK/CLK#) determines a period for which data bit patterns are transmitted and received between the controlling device 210 and the memory device 220.

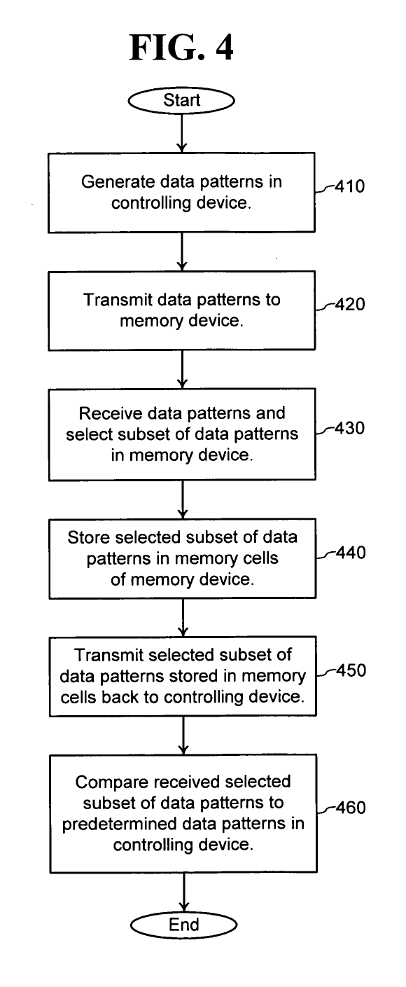

FIG. 4 shows a flow-chart of steps during data training by the components of FIG. 2. Referring to FIGS. 2 and 3, when write (WRITE) commands are generated, three data bit patterns (00, FF and 11) are transmitted through the data buses (DQ's) between the transceivers 215 and 225. Such data bit patterns are generated by the pattern generator 213 in the controlling device 210 and transmitted by the first transceiver 215 to the second transceiver 225 in the memory device 220 (steps 410 and 420 of FIG. 4).

Each data pattern is repeated four times sequentially (i.e., for four Burst Lengths (BLs)) in the example embodiment of FIG. 3. That is, in order to prevent a setup/hold violation, which can be caused when one data pattern is recorded in the memory device 220, data is transmitted in a Burst Length 4 (BL4) mode in the example embodiment of FIG. 3.

For the data patterns on the data buses (DQ's), data is read at a rising edge and/or a falling edge of a predetermined clock signal (DQS). At this time, in order to prevent the setup/hold violation, the selecting unit 223 according to the present invention selects any one of the same four data bit patterns that are sequentially transmitted to be stored in the memory cells of the storing unit 221. Broadly, the controlling device 210 generates and transmits a plurality of data bit patterns. Thereafter, the selecting unit 223 selects a subset of such data bit patterns as received at the memory device 220 to be stored in the memory cells of the storing unit 221 (step 430 of FIG. 4).

In one example of the present invention, the selecting unit 223 selects a middle one of the two data bit patterns disposed between an earliest one and a latest one of the four same data bit patterns that are sequentially transmitted. Broadly, the selecting unit selects a middle one of at least three substantially same data bit patterns that are received sequentially. Alternatively, the selecting unit 223 selects one of two substantially same data bit patterns that are received sequentially, and the selecting unit 223 selects an arbitrary one of two substantially different data bit patterns that are received sequentially.

In an alternative embodiment of the present invention, the selecting unit 223 selects a majority one of at least three data bit patterns that are received sequentially. The majority one of the data bit patterns is the data bit pattern present in most of the data bit patterns sequentially received at the memory device 220.

The subset of the data bit patterns as selected by the selecting unit 223 is stored in the memory cells of the storing unit 221 (step 440 of FIG. 4). Then, referring to FIGS. 2 and 3, when read (READ) commands are generated, the data bit patterns stored in the memory cells of the storing unit 221 are transmitted back to the controlling device 210 (step 450 of FIG. 4). The second transceiver 225 in the memory device 220 transmits such data bit patterns stored in the memory cells of the storing unit 221 back to the first transceiver 215 of the controlling device 210.

Thereafter, the controlling device 210 upon receiving the subset of the data bit patterns from the memory device 220 compares such received data bit patterns to initially transmitted bit patterns to determine the level of data skew (step 460 of FIG. 4).

In this manner, data training between the memory device 220 and the controlling device 210 does not use a data pattern generator in the memory device 220. Rather, data bit patterns are stored in the memory cells of the memory device 220. Thus, the data training of the present invention more accurately reflects the actual paths and environments of the data bits that are transmitted between the memory device 220 and the controlling device 210.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for data training in a memory device, comprising:
a selecting unit that selects a subset of data bit patterns received from a controlling device; and
a storing unit comprised of memory cells of the memory device for storing the selected subset of data bit patterns.

2. The apparatus of claim 1, further comprising:
a transceiver disposed in the memory device for receiving the data bit patterns from the controlling device, and for sending the selected subset of data bit patterns stored in the memory cells back to the controlling device.

3. The apparatus of claim 1, wherein the selecting unit selects one of two substantially same data bit patterns that are received sequentially.

4. The apparatus of claim 1, wherein the selecting unit selects an arbitrary one of two substantially different data bit patterns that are received sequentially.

5. The apparatus of claim 1, wherein the selecting unit selects a middle one of at least three substantially same data bit patterns that are received sequentially.

6. The apparatus of claim 1, wherein the selecting unit selects a majority one of at least three data bit patterns that are received sequentially.

7. A system for data training a memory device, comprising:
a controlling device that transmits data bit patterns; and
a memory device including:
a selecting unit that selects a subset of the data bit patterns received from the controlling device; and
a storing unit comprised of memory cells for storing the selected subset of data bit patterns.

8. The system of claim 7, wherein the controlling device further includes:
a pattern generator for generating the data bit patterns transmitted to the memory device; and
a first transceiver for transmitting the data bit patterns to the memory device.

9. The system of claim 8, wherein the memory device further includes:
a second transceiver disposed in the memory device for receiving the data bit patterns from the first transceiver and for sending the selected subset of data bit patterns stored in the memory cells back to the first transceiver.

10. The system of claim 7, wherein the selecting unit selects one of two substantially same data bit patterns that are received sequentially.

11. The system of claim 7, wherein the selecting unit selects an arbitrary one of two substantially different data bit patterns that are received sequentially.

12. The system of claim 7, wherein the selecting unit selects a middle one of at least three substantially same data bit patterns that are received sequentially.

13. The system of claim 7, wherein the selecting unit selects a majority one of at least three data bit patterns that are received sequentially.

14. A method of data training in a memory device, comprising:
selecting a subset of data bit patterns received in the memory device from a controlling device; and
storing the selected subset of data bit patterns in memory cells of the memory device.

15. The method of claim 14, further comprising:
receiving the data bit patterns from the controlling device in a double data rate transceiver disposed in the memory device.

16. The method of claim 14, further comprising:
sending the selected subset of data bit patterns stored in the memory cells back to the controlling device.

17. The method of claim 14, further comprising:
selecting one of two substantially same data bit patterns that are received sequentially.

18. The method of claim 14, further comprising:
selecting an arbitrary one of two substantially different data bit patterns that are received sequentially.

19. The method of claim 14, further comprising:
selecting a middle one of at least three substantially same data bit patterns that are received sequentially.

20. The method of claim 14, further comprising:
selecting a majority one of at least three data bit patterns that are received sequentially.
